(19) United States
(12) Patent Application Publication
(10) Pub. No.: US 2020/0091586 A1
(43) Pub. Date: Mar. 19, 2020

(54) MOBILE TERMINAL

(71) Applicant: LG ELECTRONICS INC., Seoul (KR)

(72) Inventors: Jaehyun CHOI, Seoul (KR); Songyi LEE, Seoul (KR); Yeomin YOUN, Seoul (KR); Hyengcheul CHOI, Seoul (KR); Chisang YOU, Seoul (KR); Hyunju YI, Seoul (KR)

(73) Assignee: LG ELECTRONICS INC., Seoul (KR)

(21) Appl. No.: 15/747,733

(22) PCT Filed: Sep. 3, 2015
(86) PCT No.: PCT/KR2015/009298

§ 371 Date: Jan. 25, 2018

(30) Foreign Application Priority Data
Jul. 30, 2015 (KR) 10-2015-0107907

(51) Int. Cl. H01Q 1/24; H01Q 1/38; H01Q 9/42; H04M 1/02; H01Q 21/28

(52) U.S. Cl. CPC H01Q 1/243; H01Q 1/38; H01Q 21/28; H04M 1/0202; H01Q 9/42

(57) ABSTRACT

According to one aspect of the present invention in order to attain the or another objective, a mobile terminal comprises: a display part; a frame which supports the back side of the display part; a rear case which is coupled to the back side of the frame; a front case which is located on at least one side of the display part side by side; a first antenna pattern which is formed one the front case; a second antenna pattern which is formed on the rear case; and a plurality of connection parts which connect the first antenna pattern and the second antenna pattern, the connection parts being spaced apart from each other. The mobile terminal can improve a performance by increasing the thickness of an emitter consisting of an antenna pattern formed on a case.

### FIELD

Embodiments of the present disclosure relate to a mobile terminal having an improved antenna performance.

### BACKGROUND

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

As such functions become more diversified, the mobile terminal can support more complicated functions such as capturing images or video, reproducing music or video files, playing games, receiving broadcast signals, and the like. By comprehensively and collectively implementing such functions, the mobile terminal may be embodied in the form of a multimedia player or device.

With enhancing the function of the multimedia, the mobile terminal includes a plurality of antennas for transceiving a signal. As transceiving the signal, using electric wave, such antennas interact with peripheral electronic components, especially, each other among the antennas. Accordingly, such the mobile terminal including the plurality of the antennas has a disadvantage of a deteriorated wireless communication function. As the mobile terminal becomes slimmer and compacter, it may be difficult to secure a space for loading the antennas.

### DETAILED DESCRIPTION OF THE INVENTION

### Technical Problem

To overcome the disadvantages, an object of the present invention is to address the above-noted and other problems and to provide a mobile terminal which may secure a space for antenna loading in a limited space and improve an antenna performance.

### Technical Solution

To achieve these objects and other advantages and in accordance with the purpose of the embodiments, as embodied and broadly described herein, a mobile terminal comprises a display unit; a frame which supports a rear surface of the display unit; a rear case coupled to a rear surface of the frame; a front case located in at least predetermined area of the display unit, in parallel; a first antenna pattern formed in the front case; a second antenna pattern formed in the rear case; and a plurality of connecting portions which connect the first antenna pattern and the second antenna pattern with each other, each of the antenna patterns comprising the plurality of the connecting portions spaced a preset distance apart from each other.

A structure of the first antenna pattern may be in symmetry with a structure the second antenna pattern.

One of the first and second antenna patterns may be shorter than the other.

At least one of the connecting portions may comprise a switch configured to selectively switch the connection between the first antenna pattern and the second antenna pattern.

The frame may comprise a metal plate made of a conductive material; and an injection-molding portion made of a non-conductive material.

The first antenna pattern and the second antenna pattern are arranged adjacent to the injection-molding portion.

The mobile terminal may further comprise one or more of an interface, an ear jack and an audio output unit which are disposed between the first antenna pattern and the second antenna pattern, and the connecting portions are arranged, without being overlapped with the interface, the ear jack and the audio output unit.

The mobile terminal may further comprise a pair of lateral metal cases coupled to lateral surfaces of the mobile terminal and comprising a conductive material; and a wireless communication unit configured to apply currents to the metal case, corresponding to a transmitted signal, wherein the first antenna pattern and the second antenna pattern are electrically connected with the lateral metal cases.

The lateral metal cases may be electrically connected with the frame in one or more areas.

The connecting portions may comprise one or more of a pogo pin or a press pin.

The front case and the rear case may be formed by an injection mold to which leather attached.

### Advantageous Effects

Accordingly, the embodiments have following advantageous effects. According to at least one embodiment of the present disclosure, the mobile terminal is capable of enhancing the performance by increasing the thickness of the radiator formed in the case, with the antenna pattern.

Furthermore, the mobile terminal is capable of enhancing the antenna performance by reducing a thickness difference between the radiator configured of the lateral frame made of metal and the radiator configured of the antenna pattern.

Still further, the mobile terminal is capable of minimizing the performance deterioration caused by the neighboring conductive material by securing the thickness without the overlapping with the metal case or frame.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

FIG. 1A is a block diagram of a mobile terminal in accordance with the present disclosure.

FIGS. 1B and 1C are conceptual views of one example of the mobile terminal, viewed from different directions;

FIG. 2 is a graph illustrating a current path according to the thickness of an antenna;

FIG. 3 is a graph illustrating the performance and VSWR (Voltage Standing Wave Ration) according to the thickness of the antenna;

FIG. 4 is a diagram illustrating a structure of an antenna and a structure of a frame in the mobile terminal;

FIG. 5 is an enlarged diagram of the antenna provided in the mobile terminal;

FIG. 6 is a diagram illustrating a first embodiment of the antenna provided in the mobile terminal in accordance with the present disclosure;

FIG. 7 is a diagram illustrating a second embodiment of the antenna provided in the mobile terminal in accordance with the present disclosure;

FIG. 8 is a diagram illustrating a third embodiment of the antenna provided in the mobile terminal in accordance with the present disclosure;

FIG. 9 is a diagram illustrating VSRW (Voltage Standing Wave Ration) of the antenna shown in FIGS. 6 through 8; and

FIG. 10 is a diagram illustrating an example of the antenna connection in the mobile terminal.

### DESCRIPTION OF SPECIFIC EMBODIMENTS

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

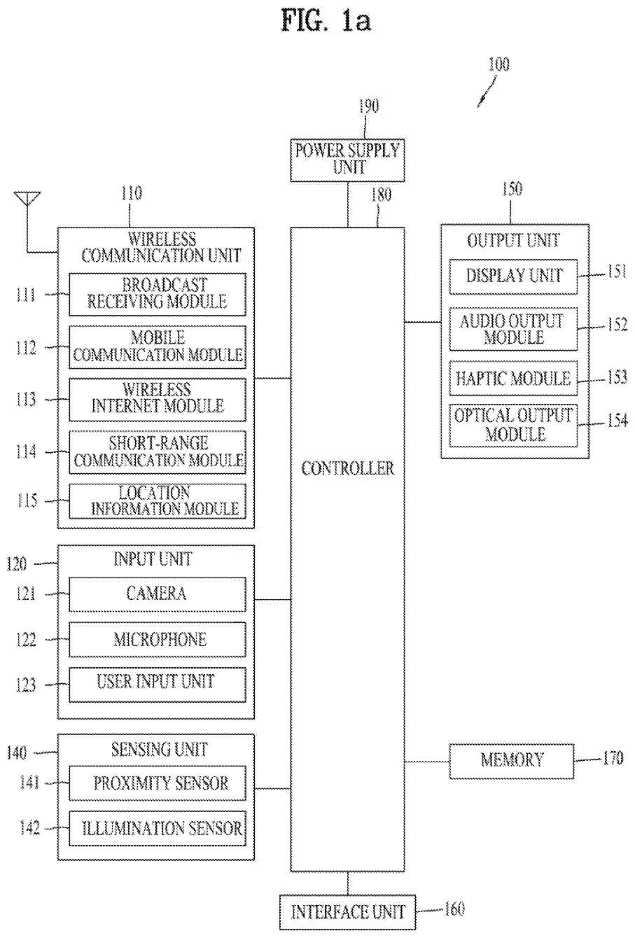

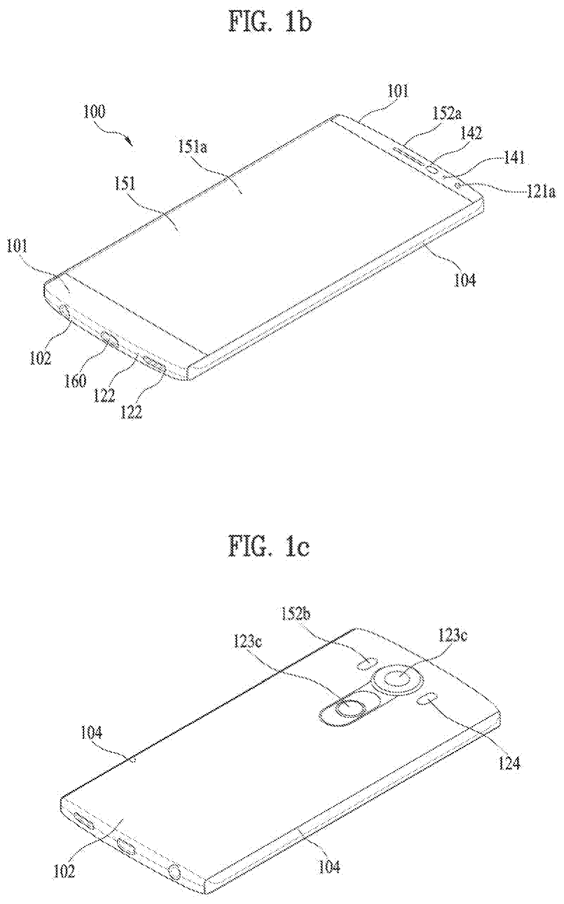

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components in the FIG. 1A is not a requirement, and that greater or fewer components may alternatively be implemented.

More specifically, the wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, the sensing unit 140 may alternatively or additionally include other types of sensors or devices, such as a proximity sensor 141 and an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output, or activating application programs stored in the memory 170.

To drive the application programs stored in the memory 170, the controller 180 may be implemented to control a predetermined number of the components mentioned above in reference with FIG. 1A. Moreover, the controller 180 may be implemented to combinedly operate two or more of the components provided in the mobile terminal 100 to drive the application programs.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Some or more of the components may be operated cooperatively to embody an operation, control or a control method of the mobile terminal in accordance with embodiments of the present disclosure. Also, the operation, control or control method of the mobile terminal may be realized on the mobile terminal by driving of one or more application problems stored in the memory 170.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

Here, the terminal body may be understood to refer to the concept of this bore a mobile terminal (100) to at least one of the aggregate.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

Such the cases 101 and 102 may be formed of synthetic resin by injection-molding or formed by printing a surface of an injection-mold or attaching a different material such as a leather or fabric.

As the display becomes larger and larger nowadays, the front case 101 may become smaller and partially located in upper and lower ends of the display unit. It is difficult to support the rigidity of the mobile terminal by using the front case 101 and the rear case 102 which partially cover the surfaces, different from the conventional case covering all of the four surfaces. Accordingly, the mobile terminal in accordance with the present disclosure may further include a lateral case 104 located in a lateral surface of the mobile terminal.

The lateral case 104 may be made of metal to support the rigidity and the metal lateral case 104 may be used as an antenna radiator.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may include the display unit 151, the audio output module, the proximity sensor 141, the illuminance sensor 142, the optical output module 154, the camera 121, the user input unit 123, the microphone 122 and the interface unit 160.

It will be described for the mobile terminal as shown in FIGS. 1B and 1C. The display unit 151, the first audio output module 151a, the proximity sensor 141, an illumination sensor 142, the optical output module 154, the first camera 121a and the first manipulation unit 123a are arranged in front surface of the terminal body, the second manipulation unit 123b, the microphone 122 and interface unit 160 are arranged in side surface of the terminal body, and the second audio output modules 151b and the second camera 121b are arranged in rear surface of the terminal body.

It is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

A flash 124 is shown located adjacent to the second camera 121b. When an image of a subject is captured with the camera 121b, the flash 124 may illuminate the subject.

The second audio output module 152b can be located on the terminal body. The second audio output module 152b may implement stereophonic sound functions in conjunction with the first audio output module 152a, and may be also used for implementing a speaker phone mode for call communication.

A power supply unit 190 for supplying power to the mobile terminal 100 may include a battery 191, which is mounted in the terminal body or detachably coupled to an outside of the terminal body.

The battery 191 may receive power via a power source cable connected to the interface unit 160. Also, the battery 191 can be recharged in a wireless manner using a wireless charger. Wireless charging may be implemented by magnetic induction or electromagnetic resonance.

At least one antenna for wireless communication may be provided in the terminal body. The antenna may be embedded in the terminal body or formed in the case. For example, the antenna partially forming the broadcasting receiving module (111, see FIG. 1a) may be retractable from the terminal body or the antenna formed of a film type may be attached to an inner surface of the rear case 102 or the case having a conductive material may function as the antenna.

The mobile terminal in accordance with this embodiment includes the lateral case 104 made of metal. The metal lateral case 104 may be used as the antenna radiator. To use the lateral case 104 as the antenna, the mobile terminal may further include a wireless communication unit connected with the lateral case 104 and configured to transceiver a wireless signal by supplying currents thereto.

A frequency band the antenna uses in wireless communication may be related with the length of the antenna. The length of the lateral case 104 is limited by the length of the mobile terminal. When a longer or shorter radiator is required, an auxiliary structure has to be provided.

In case a shorter radiator is required (a high frequency signal is transceived), the lateral case 104 may be formed shorter or cut in a middle area and the middle area is filled with a non-conductive material so as to adjust the length of the radiator. However, such methods have a problem of a degraded external appearance of the mobile terminal. Accordingly, the lateral case 104 is grounded so adjust currents to flow in the limited length.

In case a longer radiator is required, an auxiliary antenna pattern 211 and 212 may be formed in the rear case 102 and the rear case 102 is connected with the lateral case 104 to adjust the frequency. However, there is a remarkable difference between the sizes of the radiators, when the antenna pattern 211 and 212 formed in the rear case 102 is connected with the case defining the exterior appearance of the mobile terminal.

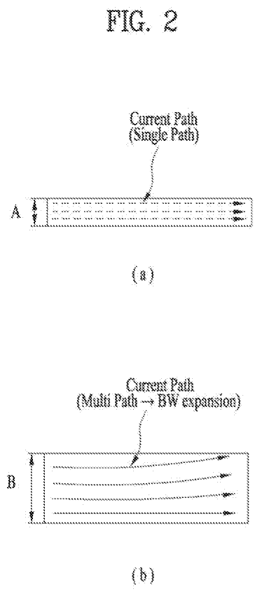

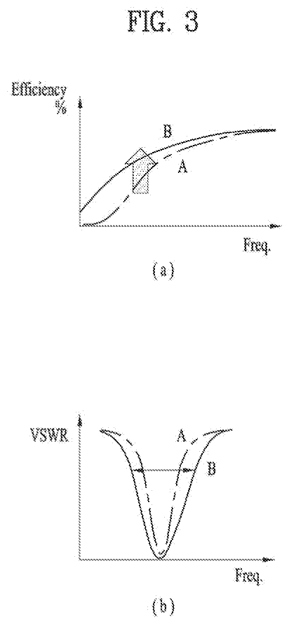

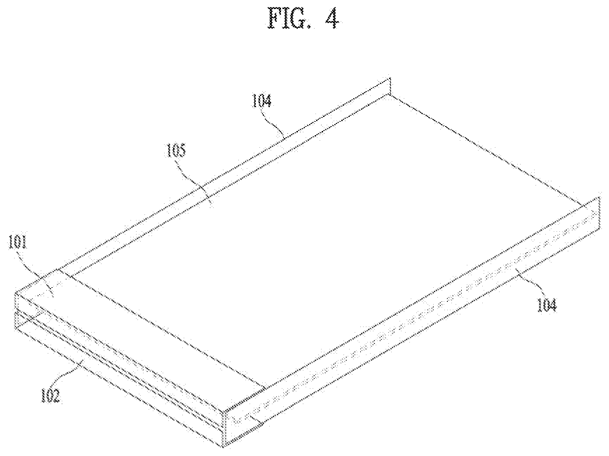

FIG. 2 is a graph illustrating a current path according to the thickness of an antenna. FIG. 3 is a graph illustrating the performance and VSWR (Voltage Standing Wave Ration) according to the thickness of the antenna.

Antenna efficiency appears large as reducing the energy lost in the radiator. The energy consumed in the radiator is related with resistance of the radiator. As the resistance is stronger, the energy consumed in the radiator becomes larger and it becomes important to reduce the resistance of the radiator.

The resistance of the radiator is related with the thickness of the radiator. The thicker is the radiator, the more smoothly currents flow and the weaker is the resistance. As shown in FIG. 3, the efficiency of the radiator shown in FIG. 2(b) is higher than that of the radiator shown in FIG. 2(a).

As the radiator becomes thicker, a path of currents may be differentiated and a band of resonance frequency becomes broad. When the radiator is thin, the current path is consistent as shown in FIG. 2(a).

When the radiator is thick, currents flow in parallel with or inclined with respect to the extended direction of the radiator as shown in FIG. 2(b) so that the current path may become diversified. Accordingly, the resonance frequency is resonated with the frequency with a wavelength which is four times as long as the radiator and the frequency with a wavelength which is four times as long as a diagonal line of the radiator.

The graph of FIG. 3(b) illustrating VSWR shows a large value in a downward direction in a frequency band having a high efficiency. As a frequency band having a preset value or less is wider, the resonance frequency means wider. Accordingly, a radiator (B) shown in FIG. 2(b) is capable of trasnsceiving a signal in a broader frequency band than a radiator (A) shown in FIG. 2(b).

Accordingly, it is necessary the mobile terminal in accordance with the present disclosure should have the radiator which is as broad as possible. The lateral case 104 has a low degree of transformation freedom because of the design problem. However, it is relatively easy to deform the shape of the antenna located in the mobile terminal 100. The antenna pattern 211 and 212 formed in the case of the mobile terminal 100 may provide a structure which may enhance the performance.

The lateral case 104 of the mobile terminal 100 may include a frame 105 which supports a rear surface of the display unit. The frame 105 may be made of metal to support the rigidity or provide a ground of electronic components such as the antenna.

As the frame 105 made of metal affects an electromagnetic wave, it is preferred that the frame 105 is spaced a preset distance apart from the antenna. Accordingly, the antenna formed in an inner surface of the rear case 102 cannot be formed in an entire area of the rear case 102 and even the antenna formed in the inner surface of the case is substantially arranged in a limited area. Avoiding the frame 105, the antenna pattern 211 and 212 is formed in an upper or lower end area of the rear case 102 and the thickness of the antenna pattern 211 and 212 is limited.

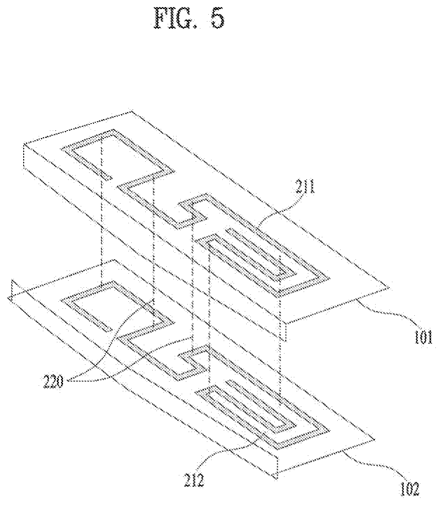

To solve the problem, the antenna pattern 211 and 212 in accordance with the present disclosure may be formed in both the front case 101 and the rear case 102 as shown in FIG. 5. It is impossible to provide the radiator with a preset thickness and a preset length corresponding to the wavelength of the frequency, only when forming the first antenna pattern 211 in the front case 101 and the second antenna pattern 212 in the rear case 102. Accordingly, a connecting portion 220 for electrically connecting the first antenna pattern 211 with the second antenna pattern 212 with each other may be further provided.

The connecting portion 220 may connect the first antenna pattern 211 with the second antenna pattern 212 by using an elastic terminal such as a pogo pin or a C-clip or a fitting structure such as a press pin.

In case of simply connecting the first antenna pattern 211 and the second antenna pattern 212 with each other in one or two areas, the connecting portion 220 may form a flow path of currents so as to effectively extend the length of the radiator such as a loop antenna or PIFA antenna.

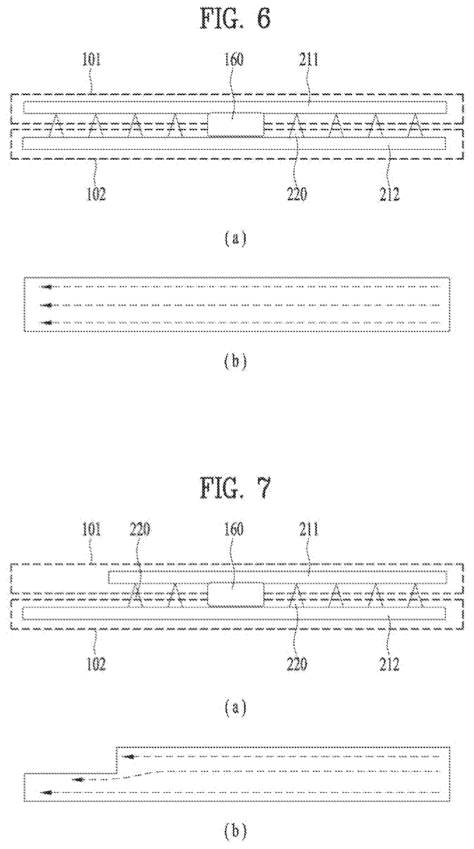

To increase the thickness of the radiator and allow the first antenna pattern 211 and the second antenna pattern 212 to satisfy the length of the radiator, the first antenna 211 and the second antenna 212 may be connected at a plurality of areas as shown in FIG. 5. FIG. 6 illustrates a first embodiment of the antenna provided in the mobile terminal 100 in accordance with the present disclosure, viewed from a lower end of the mobile terminal 100. When the first and second antenna patterns 211 and 212 are connected with each other by using a plurality of connecting portions 220 as shown in FIG. 6(a), currents flows between the first and second antenna patterns 211 and 212 and current flow is shown like one conductor substantially as shown in FIG. 6(b) only to generate an effect of an increased radiator thickness.

The connecting portion 220 shown in FIG. 6 may be arranged, avoiding the electronic components disposed in the lower end area of the mobile terminal such as the speaker 152b, the ear jack and the like. When the first and second antenna patterns 211 and 212 are arranged in the upper end area of the mobile terminal, the connecting portion 220 may be arranged avoiding the camera 121a and 121b or the receiver 152a.

The first and second antenna patterns 211 and 212 are formed in symmetry as shown in FIG. 6. In contrast, they may be formed in asymmetry as shown in FIG. 7(a). In this instance, the current flow may be differentiated as shown in FIG. 7(b) and the frequency band may be changed minutely. Wireless communication is performed by using a different frequency band according to a communication company or region so that the frequency may be tuned by changing the pattern according to the communication company or region.

FIG. 9 is a diagram illustrating VSRW (Voltage Standing Wave Ration) of the antenna shown in FIGS. 6 through 8. The resonance frequency (a) shown in the embodiment of FIG. 6 is different from the resonance frequency (b) shown in the embodiment of FIG. 7.

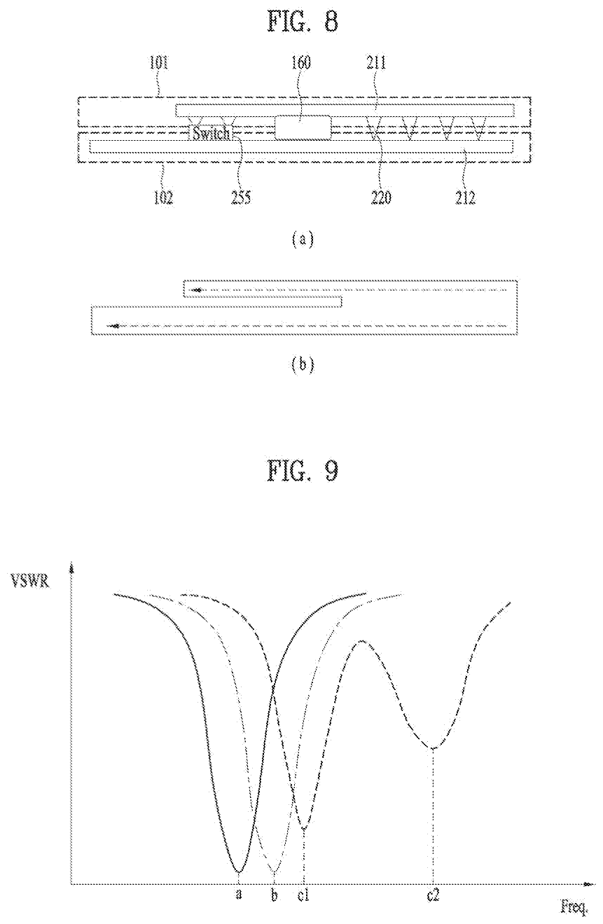

FIG. 8 is a diagram illustrating a third embodiment of the antenna provided in the mobile terminal 100 in accordance with the present disclosure. A switch 225 is disposed in the connecting portion 220 to selectively connect the first antenna pattern 211 with the second antenna pattern 212. When the switch 225 is switched on, the first and second antenna patterns 211 and 212 are connected to become an antenna shown in FIG. 7. When the switch 225 is switched off, the first and second antenna patterns 211 and 212 are connected to form a radiator shown in FIG. 8(b). In this instance, the radiator is divided into two parts. In a state where the switch 225 is switched off, the antenna shown in FIG. 8 is resonated in two frequencies (c1 and c2) (see FIG. 9). In case of using the antenna patterns 211 and 212 having such the structure, a multiband antenna may be realized.

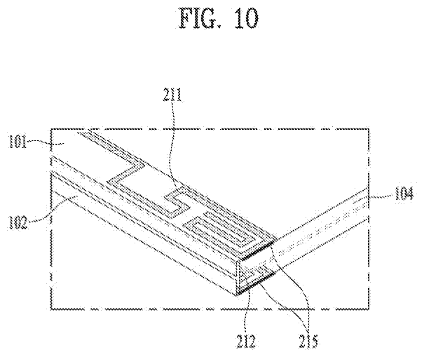

FIG. 10 is a diagram illustrating an example disclosing that the lateral case 104 is connected with the antenna patterns 211 and 212 of the mobile terminal in accordance with the present disclosure. The first and second antenna patterns 211 and 212 are connected (215) with the lateral case 104 made of metal. The conventional antenna patterns 211 and 212 are located only in the rear case 102 so that the radiator may become relatively thinner than the lateral case 104.

However, the antenna patterns shown in the embodiments of the present disclosure are formed in the front case 101 and the rear case 102, respectively, as shown in FIG. 10 and connected with each other at a plurality of areas by the connecting portion 220. Accordingly, an effect may occur that the thick radiator is connected.

If the thickness of the radiator is differentiated, the antenna performance is likely to deteriorate. The radiator including the first antenna pattern 211 formed in the front case 101, the second antenna pattern 212 formed in the rear case 102 and the connecting portion 220 connecting the antenna patterns 211 and 212 with each other is capable of reducing the thickness difference between the lateral case 104 and the radiator. Accordingly, the antenna performance can be enhanced.

According to at least one of the embodiments mentioned above, the mobile terminal may have the enhanced antenna performance by the increase of the radiator configured of the antenna patterns 211 and 212 formed in the case.

Furthermore, the antenna performance may be improved by reducing the thickness difference between the radiator configured of the lateral frame 105 and the radiator configured of the antenna patterns 211 and 212.

Still further, the predetermined thickness of the radiator can be secured without being overlapped with the metal case or frame 105. Accordingly, the performance deterioration caused by the neighboring conductive material may be reduced.

The computer may include the controller 180 of the mobile terminal. As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

1. A mobile terminal comprising:
a display unit;
a frame which supports a rear surface of the display unit;
a rear case coupled to a rear surface of the frame;
a front case located in at least predetermined area of the display unit, in parallel;
a first antenna pattern formed in the front case;
a second antenna pattern formed in the rear case; and
a plurality of connecting portions which connect between the first antenna pattern and the second antenna pattern, each of the plurality of the connecting portions spaced apart from each other.

2. The mobile terminal of claim 1, wherein a structure of the first antenna pattern is in symmetry with a structure the second antenna pattern.

3. The mobile terminal of claim 1, wherein one of the first and second antenna patterns is shorter than the other.

4. The mobile terminal of claim 1, wherein at least one of the connecting portions comprises a switch configured to selectively switch the connection between the first antenna pattern and the second antenna pattern.

5. The mobile terminal of claim 1, wherein the frame comprises,
a metal plate made of a conductive material; and
an injection-molding portion made of a non-conductive material, and
the first antenna pattern and the second antenna pattern are arranged adjacent to the injection-molding portion.

6. The mobile terminal of claim 1, further comprising:
one or more of an interface, an ear jack and an audio output unit which are disposed between the first antenna pattern and the second antenna pattern, and
the connecting portions are arranged, without being overlapped with the interface, the ear jack and the audio output unit.

7. The mobile terminal of claim 1, further comprising:
a pair of lateral metal cases coupled to lateral surfaces of the mobile terminal and comprising a conductive material; and
a wireless communication unit configured to apply currents to the lateral metal case, corresponding to a transmitted signal,
wherein the first antenna pattern and the second antenna pattern are electrically connected with the lateral metal cases.

8. The mobile terminal of claim 7, wherein the lateral metal cases are electrically connected with the frame in one or more areas.

9. The mobile terminal of claim 1, wherein the connecting portions comprise one or more of a pogo pin or a press pin.

10. The mobile terminal of claim 1, wherein the front case and the rear case are formed by an injection mold to which leather attached.

11. A mobile terminal comprising:
a display unit;
a frame which supports a rear surface of the display unit;
a rear case coupled to a rear surface of the frame;
a front case located in at least predetermined area of the display unit, in parallel;
a first antenna pattern formed in the front case;
a second antenna pattern formed in the rear case; and
a plurality of connecting portions which connect between the first antenna pattern and the second antenna pattern, each of the plurality of the connecting portions spaced apart from each other
wherein a length of the second antenna pattern and a length of the first antenna pattern is different, and
wherein at least one of connecting portions comprises a switch configured to selectively switch the connection between the first antenna pattern and the second antenna pattern.
